(19) United States
(12) Patent Application Publication
(10) Pub. No.: US 2007/0061221 A1
(43) Pub. Date: Mar. 15, 2007

(54) PROCESS FOR GENERATING REVENUE THROUGH PLACEMENT OF FREE COMPUTERS AND ONLINE WEB ACCESS

(75) Inventor: Douglas M. Higgins, Culver City, CA (US)

Correspondence Address: KELLY LOWRY & KELLEY, LLP, 6320 CANOGA AVENUE, SUITE 1650, WOODLAND HILLS, CA, 91367, US

(73) Assignee: INMOR CORPORATION, Culver City, CA (US)

(21) Appl. No.: 11/531,432

(22) Filed: Sep. 13, 2006

Related U.S. Application Data
(60) Provisional application No. 60/716,820, filed on Sep. 13, 2005.

(51) Int. Cl. G06Q 30/00

(52) U.S. Cl. 705/26

(57) ABSTRACT

A process for generating revenue whereby customers are enrolled in a subscription program. Under the program, customers are given a free computer and internet access in exchange for agreeing to purchase a minimum amount of products and/or services from vendors associated with the program. Revenue is generated through the collection of money for the products and/or services purchased, at least a portion of which goes to the vendors as full payment for the products and/or services purchased.

### BACKGROUND OF THE INVENTION

The present invention generally relates to internet commerce. More particularly, the present invention relates to generating revenue by providing Internet access.

The explosion of the internet and World Wide Web has created a new frontier in capitalism. There have been many attempts to encourage individuals to move their commercial transactions (e.g., purchase of goods, services, etc.) from in-person or over-the-phone transactions at brick-and-mortar establishments to electronic, web-based companies.

Drawbacks have included the fact that not every household has a computer or internet access. This can be due to various reasons including the cost/affordability of a computer and/or internet access. Even a basic computer can still cost several hundred dollars and computer users must still pay monthly access fees to internet service providers in order to gain access the Internet from their home.

Accordingly, there is a need for a process by which those without computers or with outdated computers can obtain a new computer and Internet access. There is a further need for a process by which a computer and Internet access can be used to conduct transactions for a variety of goods and/or services through a website.

### SUMMARY OF THE INVENTION

A process for generating revenue by providing free computers and internet access. The process begins by establishing minimum requirements for enrollment in a subscription program and requiring applicants to the subscription program to complete a survey to identify those applicants that meet the minimum requirements. Information about the surveys is stored in a database.

Applicants that meet the minimum requirements are given the option of enrolling in the subscription program. In the subscription program, the applicants agree to purchase a minimum amount of products and/or services from vendors associated with the subscription program. Applicants that enroll in the subscription program become customers. In addition to storing information about the surveys, the database stores information about the customers, as well as information about the vendors and the products and/or services offered.

As part of the subscription program, the customers are provided with a free computer and internet access in exchange for their agreement to purchase the minimum amount of products and/or services. The free computer and internet access is setup for the customers and the customers are provided access to a portion of the database through the free computer and internet access. The accessible portion of the database includes information about the vendors, the products and/or services, and the specific customer accessing the database. The computer is connected to an e-commerce web-site with access to the database and the customer is logged onto the e-commerce web-site. Revenue is generated by collecting money from the customers, at least a portion of which goes to the vendors as full payment for the minimum amount of products and/or services purchased.

The process further includes identifying those applicants that meet the minimum requirements as prospective customers; and sending an offer to enroll in the subscription program to the prospective customers. Prospective are given the option of enrolling in the subscription program on-line or in-person.

When on the e-commerce website, the customers are permitted to search, browse products and/or services, add products and/or services to a shopping cart or wish list, view the shopping cart or wish list, and remove products and/or services from the shopping cart or wish list on the e-commerce web site. When a customer is ready to make a purchase, the items contained in the shopping cart are submitted for checkout. The customer provides payment information and the order and shipping information are transmitted a vendor for the products and/or services in the shopping cart. The customer's order is then fulfilled.

Other features and advantages of the invention will become more apparent from the following detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 is a system architecture diagram;

FIG. 2 is a flowchart illustrating the process by which a prospective customer is identified;

FIG. 3 is a flowchart illustrating the process by which a prospective customer is identified and is a continuation of the flowchart in FIG. 2;

FIG. 4 is a flowchart illustrating an approval process by which a prospective customer is approved;

FIG. 5 is a flowchart illustrating how a customer gets onto the system through a computer provided to them;

FIGS. 6 and 7 are flowcharts illustrating how a web visitor can use the system and/or become a customer;

FIG. 8 is a flowchart illustrating accessing of web tutorials;

FIG. 9 is a high-level flowchart illustrating use of the eCommerce web site;

FIG. 10 is a flowchart illustrating a checkout process;

FIG. 11 is flowchart illustrating a reporting process;

FIG. 12 is a flowchart illustrating use of a transactions processing database;

FIG. 13 is a flowchart illustrating use of a analytical processing database;

FIG. 14 is a flow chart illustrating a vendor's relationship with the company;

FIG. 15 is a merchant companies flowchart illustrating the payment process;

FIG. 16 is a shipping companies flowchart illustrating the shipping process;

FIG. 17 is a flowchart illustrating technical support and customer service;

FIG. 18 is a diagram illustrating connections between elements of the system with the web browser at the hub of the system;

FIG. 19 is a browser data workflow diagram;

FIG. 20 is another browser data workflow diagram;

FIG. 21 is yet another browser data workflow diagram; and

FIG. 22 is a flowchart illustrating browser data flow.

### DETAILED DESCRIPTION OF THE PREFERRED EMBODIMENT

The purpose of the present invention is for a company to provide a free computer and free internet access to customers in exchange for those customers agreeing to purchase a certain amount of goods and/or services over the Internet through a web-site set up by the company.

A system 30 of providing customers with access to products and/or services includes a collection of independent but interrelated technologies comprising a unified whole: software, hardware, network, database, user interface, customer support, etc. which all work together to serve a common purpose of providing affordable computers and Internet access to those households that do not currently have them. In exchange for the computers and Internet access, households will purchase a specified monetary amount of goods and services online through the company's web-site during a specified period of time.

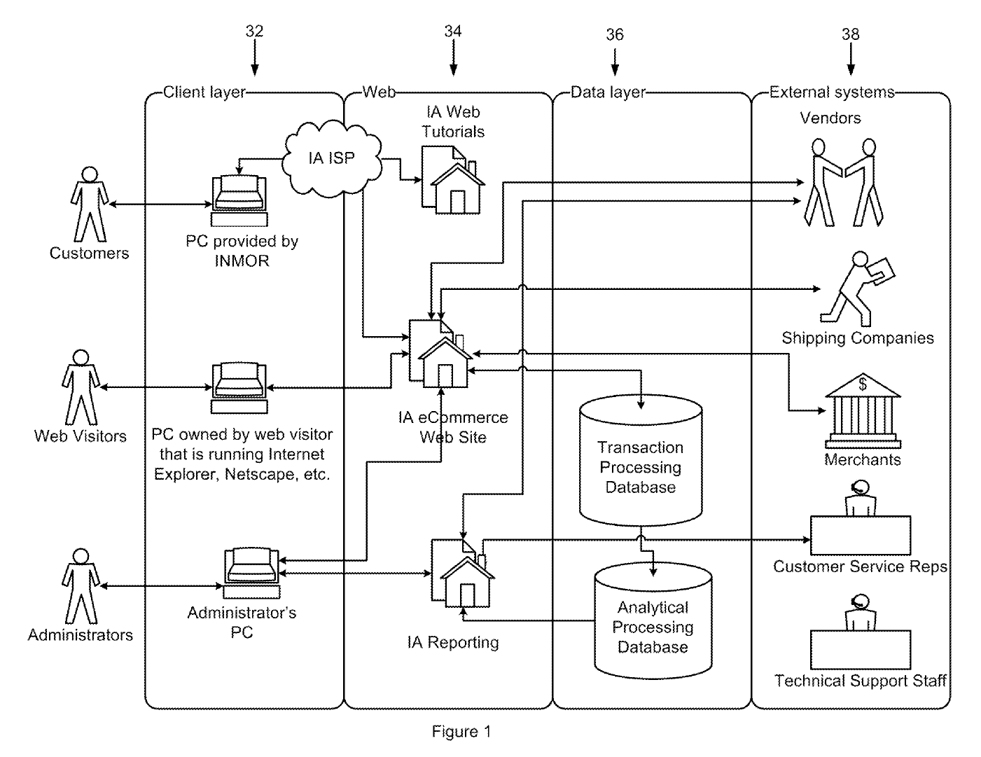

As seen in FIG. 1, there are several layers to the system 30 including a client layer 32, a web layer 34, a data layer 36 and an external systems layer 38. The client layer 32 includes a personal computer (PC) provided free to an individual in exchange for that individual agreeing to become a customer who will purchase a certain monetary amount of goods and/or services through the company's web-site during a given time period. The time period could be for any selected period of time (e.g., monthly, quarterly, or yearly). At the web layer 34, the PC will have a web browser pre-installed and will have a basic tutorial on how to use the computer and the web-site through which transactions will be made. Internet service will also be provided to the customer. Most tutorials will be web-based.

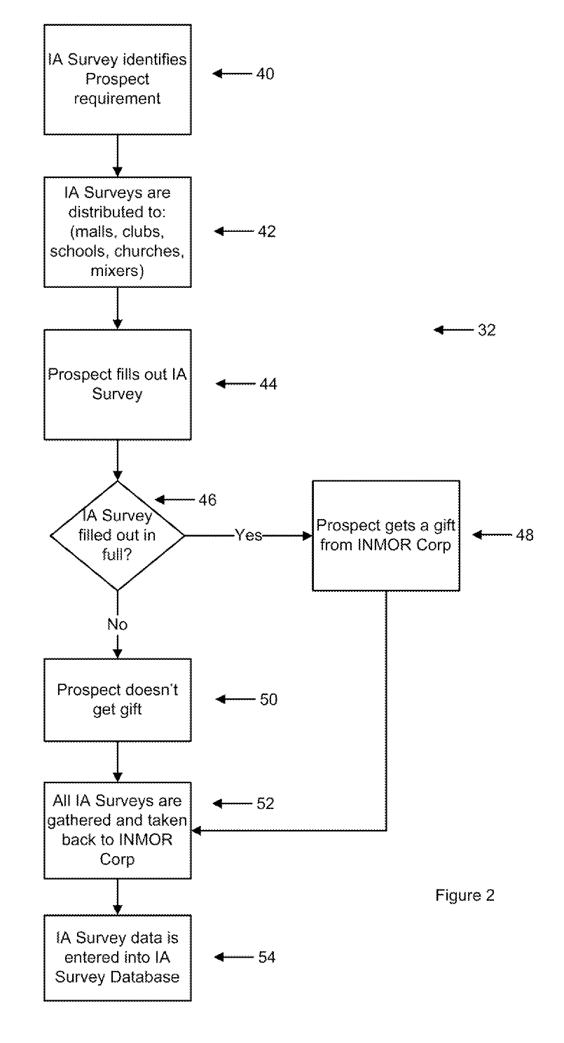

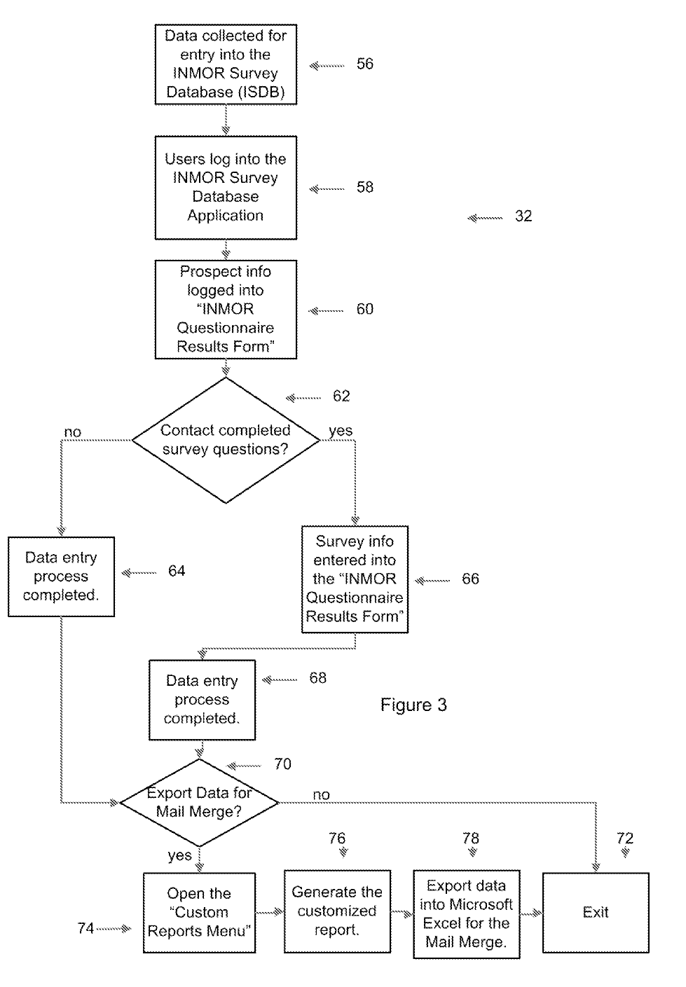

As illustrated in FIGS. 2-3, a company survey will be used to identify prospective customers who meet certain requirements 40. The surveys are distributed to various target groups at various locations including, without limitation, shopping malls, clubs, schools, churches, social mixers, etc. 42, where a prospective client fills out the survey 44. What happens next depends upon whether or not the survey is filled out in full 46. If the survey is filled out in full, the prospect gets a gift from the company 48. If the survey is not filled out in full, the prospect does not get a gift 50. In either event, all surveys are gathered and taken back to the company for further processing to determine who is eligible to become a customer 52. The survey data is then entered into a survey database 54.

Survey data collected for entry into the survey database is then processed using a survey database software application 56 (FIG. 3). A user employed by the company logs into the survey database application 58. Prospective customer personal information is logged into a Company Questionnaire Results Form using a “Contacts” tab key of the application 60. What happens next depends upon whether the prospective customer (or “contact”) answered any questions on the survey 62. If no questions were answered, the data entry process is then completed 64. If one or more of those questions were answered, the survey information is logged into the Company Questionnaire Results Form using a “Survey Results” tab key of the application 66 and the data entry process is then completed 68. What happens next depends upon whether or not the data is ready to be exported for a mail merge 70. If the data is not ready (i.e., “no”), then the user exits the survey database application 72. If the data is ready, then the user opens the ‘Custom Reports Menu’ to generate customized data for the mail merge 74. The user then selects the desired report options and generates the customized report 76. The user then exports the data from the survey database application into MICROSOFT EXCEL or a similar program for the mail merge 78. The user then exits the survey database application 72.

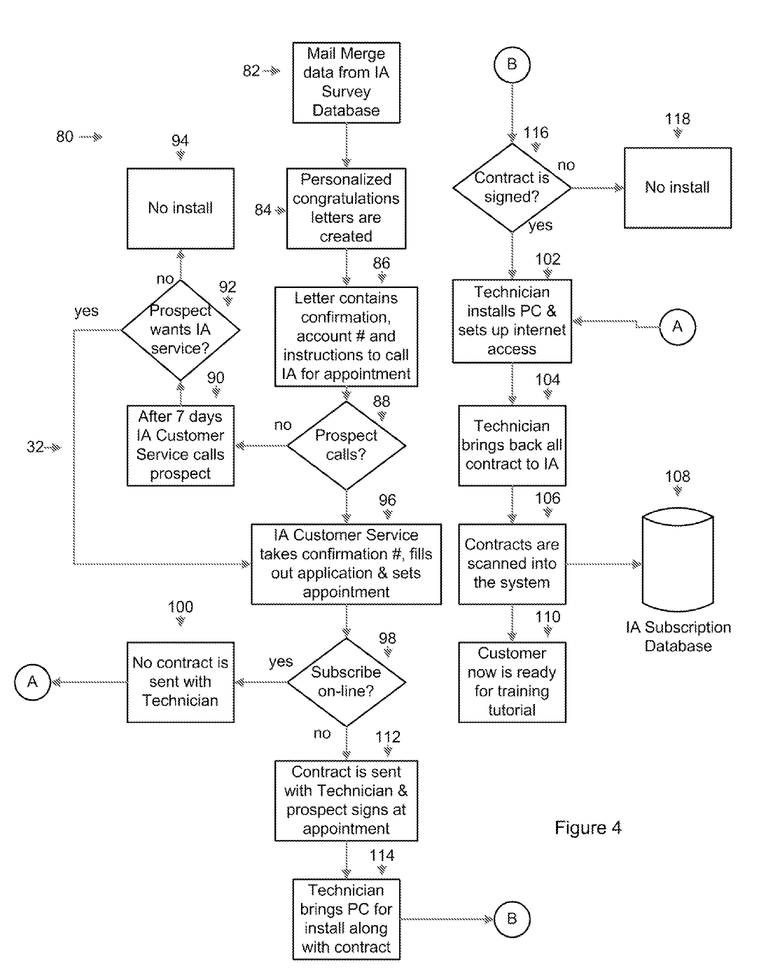

An approval process 80 (FIG. 4) starts with Mail merge data from the survey database application 82. Personalized congratulations letter are created from the data file from the survey database 84. Each letter contains a confirmation, account number and instructions to call the company for an appointment 86. When happens next depends on whether or not the prospect calls 88. If not, then after a period of time (e.g., seven days), the company customer service calls the prospect 90. The prospect has a choice of whether or not to take advantage of the company's service 92. If the prospect decides not to take advantage, then no service is installed 94. If the prospect says “yes” to using the company's service, then the same thing happens as if the prospect had called, that is, customer service takes the confirmation number, fills out an application for the prospect and sets up an appointment 96. The prospect, now a customer, is given a choice of whether or not to subscribe online 98. If yes, the prospect/customer makes a contact with the company on-line and no written contract for the customer to sign is sent out with the technician who delivers a PC to the customer and sets up the Internet service 100. The technician then installs a PC and sets up Internet access 102.

If the customer chooses not to subscribe on-line, then a contract is sent out with a technician and the prospect/customer signs the contract at the appointment 112. The technician brings the prospect/customer a PC for installation along with the contract 114. The prospect still has a choice of whether or not to sign the contract 116. If the prospect decides not to sign the contract, then the PC and Internet service are not installed 118. However, if the prospect signs the contract and becomes a customer, then the technician installs a PC and sets up Internet access 102. The technician then brings back any signed contracts to the company 104. Any written contracts are scanned into the system 106 and become part of the company's subscription database 108. The customer is now ready for a training tutorial 110.

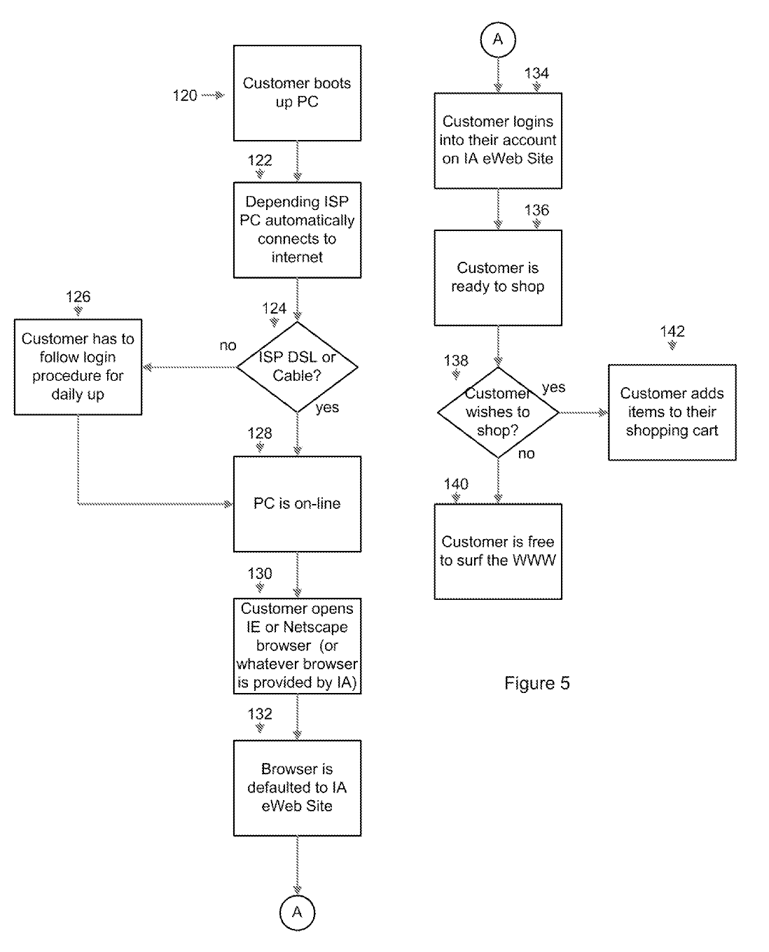

With respect to the PC provided by the company (FIG. 5), the customer boots up the PC 120. Depending on the Internet Service Provider (ISP) used by the company to connect customers to the Internet, the PC can connect the customer to the Internet 122. What happens next depends on whether the ISP is DSL or cable 124. If the ISP is not DSL or cable, then the customer has to follow login procedure for dial-up connection by modem 126 and the PC is then on-line 128. If the ISP is DSL or cable, then the PC is automatically on-line through DSL or cable 128. The customer then opens Internet Explorer (IE) or Netscape browser (or whatever browser is provided to the customer by the company) 130. The browser defaults to the company's eCommerce web-site 132. The customer then logins to their account on the web-site 134. The customer is now ready to shop 136. The customer can choose whether or not to shop 138. If the customer does not wish to shop, the customer is free to surf the web 140. If the customer wishes to shop, the customer adds items to their on-line shopping cart 142.

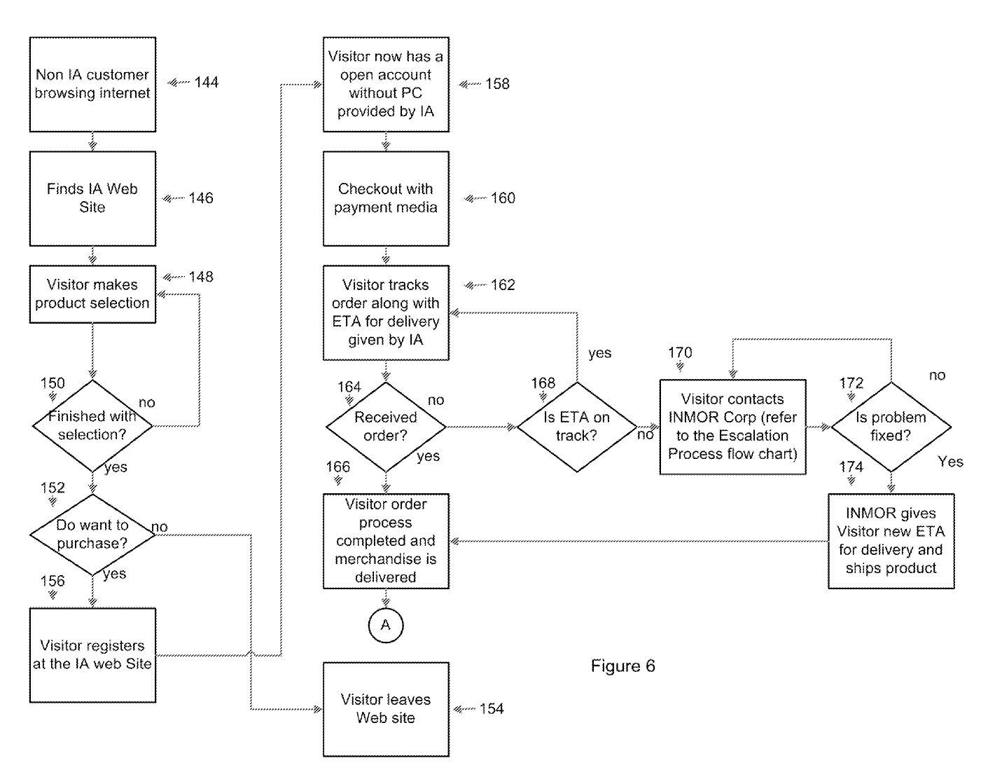

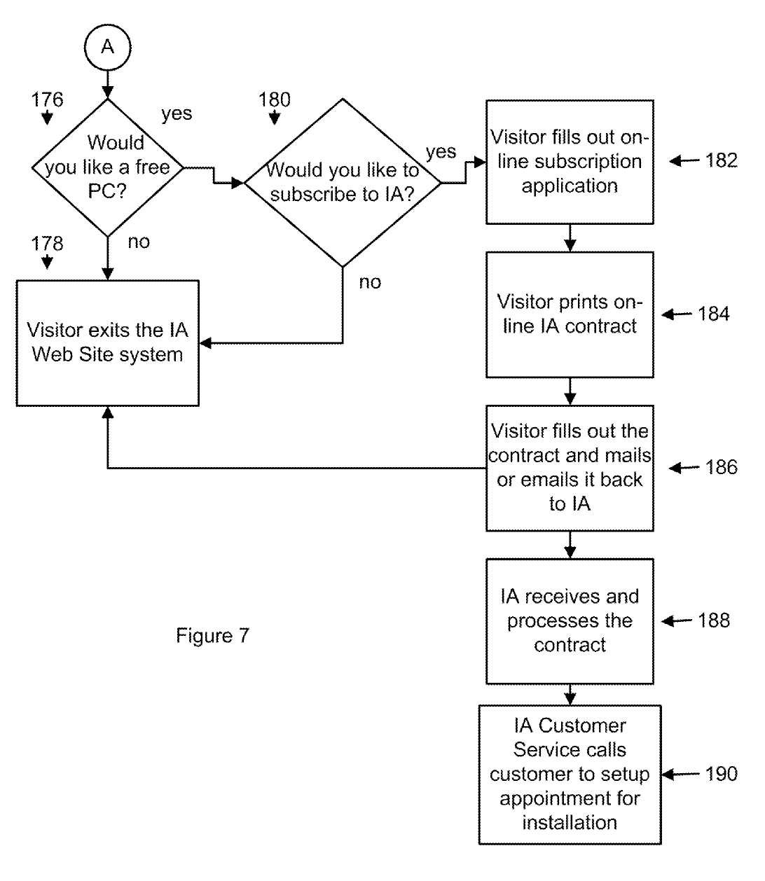

Potential clients also include web visitors with computers obtained by those web visitors on their own who will be using a web browser other than the company's Web Browser and Internet service provided by another company. With respect to a PC owned by a web visitor (FIGS. 6 and 7), a non-company customer browsing the Internet 144 finds the company's eCommerce web site 146. The visitor can make product selections 148. The visitor has a choice to finish making selections or to continue selecting products 150. The visitor then has a choice of whether or not to purchase the selected items 152. If the visitor does not wish to purchase the items, the visitor can then leave the web site 154. If the visitor wishes to purchase the items, the visitor then registers with the company's web site 156. If the visitor has previously registered, then the visitor can choose to login to their account at the start or when they are ready to purchase selected items. The visitor has now opened an account without their having a PC provided by the company 158. The visitor/customer then checks out with payment media 160. The visitor can track their order along with estimated time of arrival (ETA) for delivery given by the company 162. The question becomes whether or not the visitor has received their order 164. If the visitor receives their order, then the visitor order is completed and merchandise is delivered 166. If not, then the visitor/customer queries to see if the ETA is on track 168. If the ETA is on track, then the visitor can continue to track their order until that order is received 162, 164. If the ETA is not on track, then the visitor contacts the company to resolve the issue 170, 172. If the problem is not fixed, then the visitor continues to contact the company until the issue is resolved 170. If the problem is fixed, then the company gives the visitor a new ETA for delivery and ships the product 174. The visitor order is completed and merchandise is delivered 166.

Once the order is completed and the merchandise is delivered, the visitor is asked if they would like a free PC 176 (FIG. 7). If they do not want a free PC, then the visitor exits the company's web site system 178. If they do want a free PC, the visitor is asked if they would like to subscribe to the company 180. If the visitor does not wish to subscribe, then the visitor exits the company's web site system 178. If they do want to subscribe, then the visitor fills out an on-line subscription application 182. The visitor prints the on-line company contract 184. The visitor fills out the contacts and mails or emails the contact back to the company 186. The visitor can then exit the website 178. The company receives and processes the contract 188. Customer service then calls the new customer to set up an appointment for installation 190. From that point on, transactions occurring with respect to that customer are the same as those customers provided with a computer and Internet service by the company in FIGS. 4 and 5.

The client layer 32 further includes administrators who will use company PCs to perform tasks such as troubleshooting escalated installation and connectivity problems and deploying new versions of the browser software. The company PCs allow the administrators to connect to company reporting. The administrator performs administrative tasks such as viewing sales reports and usage reports.

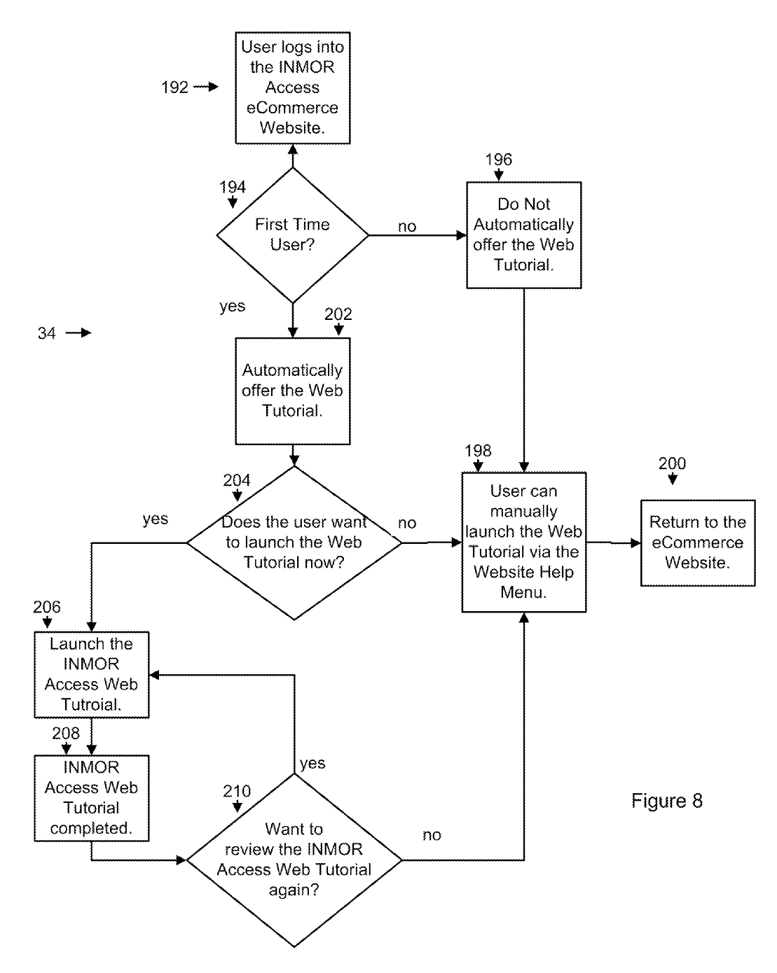

As seen in FIG. 8, the Web Layer 34 includes Web Tutorials. The company's web Tutorials are delivered via the Internet. The tutorials are targeted primarily at novice users. These tutorials can be optional or mandatory the first time a customer accesses the web layer. The tutorial begins with a customer/user logging into the company's eCommerce website 192. It is then determined if the user is a first time user logging into the website 194. If the user is not a first time user logging into the website, then the user is not automatically offered the web tutorial 196. The user can still manually launch the web tutorial via the website help menu 198 and then return to the website when finished 200. If the user is a first time user logging into the website, then the user is automatically offered the web tutorial 202. The user is queried if the user wants to launch the web tutorial at that time 204. If not, then user can still manually launch the web tutorial via the website help menu 198 and then return to the website when finished 200. If the user does launch the web tutorial at that time, then the web tutorial is launched 206 and the tutorial proceeds until completed 208. The user then has a choice of reviewing the tutorial and going through the tutorial again 210. If the user chooses not to review the tutorial, then user can still manually launch the web tutorial via the website help menu 198 and/or return to the website 200.

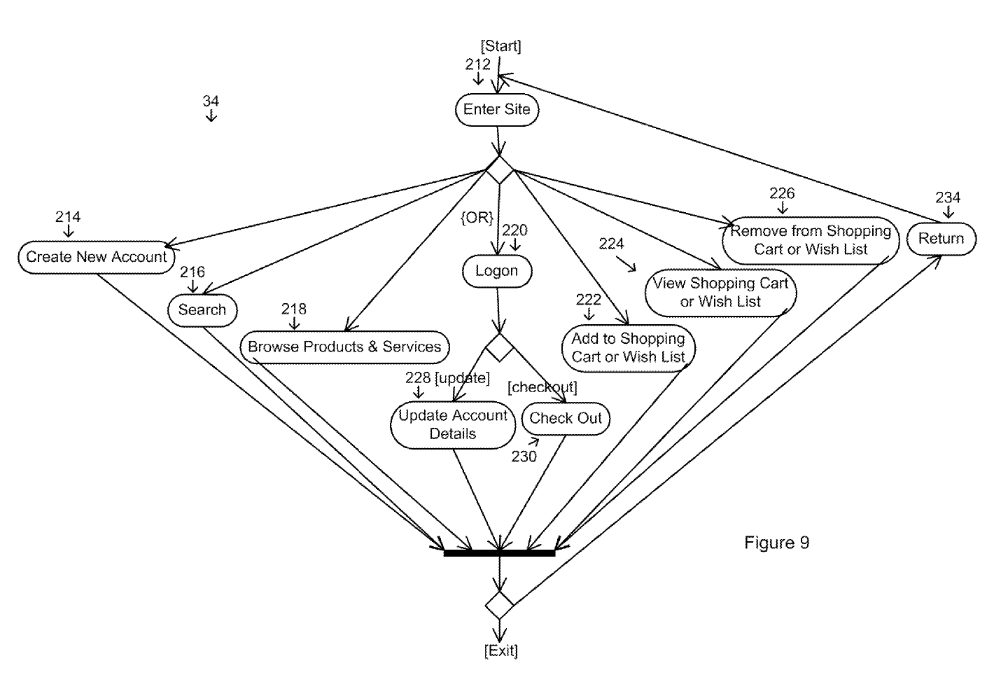

As outlined in FIG. 9, the web layer 34 also includes the company's eCommerce web-site which allows customers to login and shop using on-line vendors and to browse business opportunities. Various languages will be supported. (English, Spanish, etc.). A user enters the web site 212 and has variety of choices: create new account 214, search 216, browse products and services 218, logon 220, add to shopping cart or wish list 222, view shopping cart or wish list 224, and remove from shopping cart or wish list 226. If a user chooses to logon 220, the user can then update their account details 228 or checkout (with or without having chosen goods and/or services) 230. A user can choose 232 to either return to the site 234 or exit from the website 236.

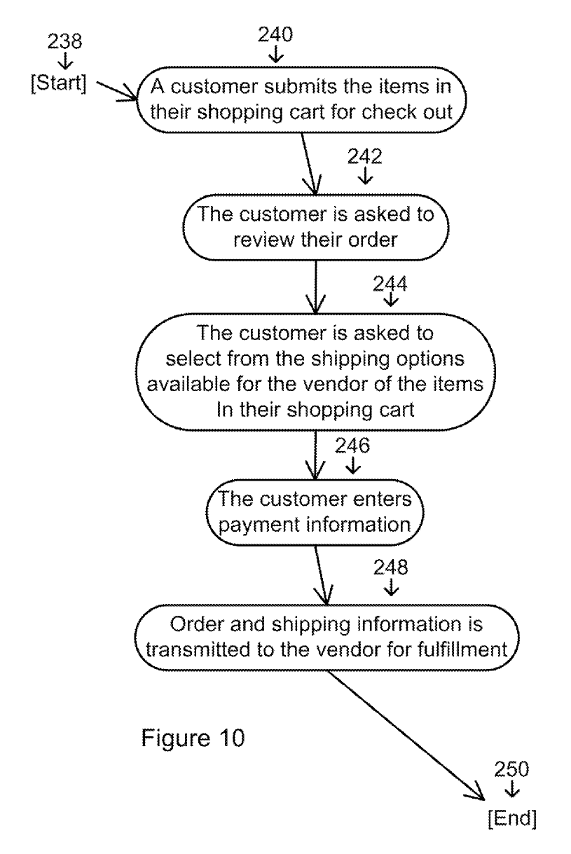

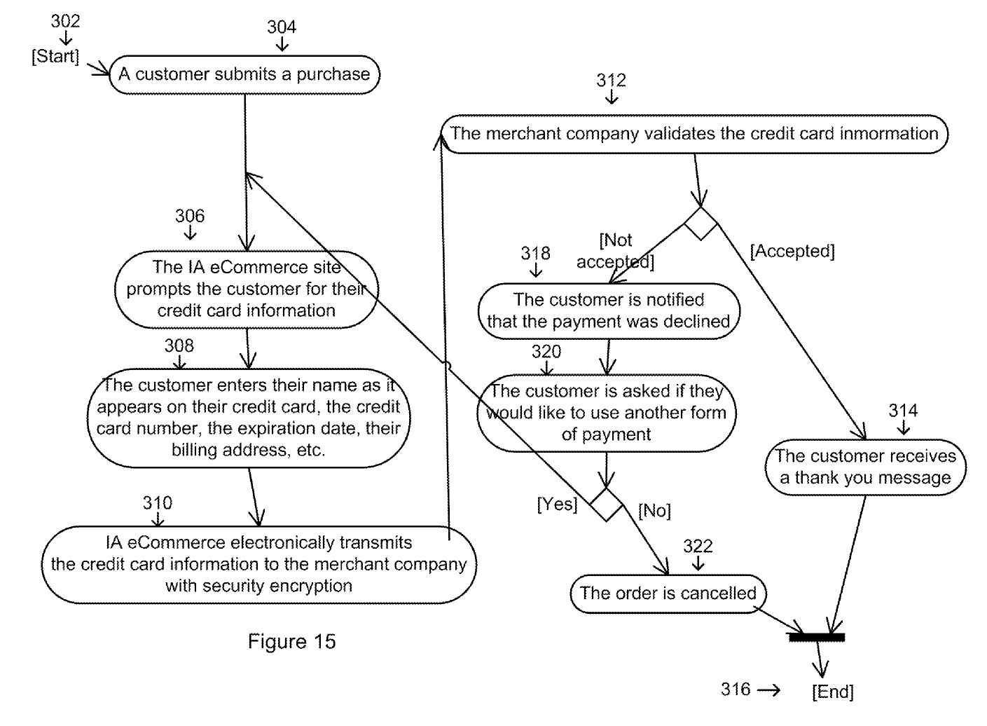

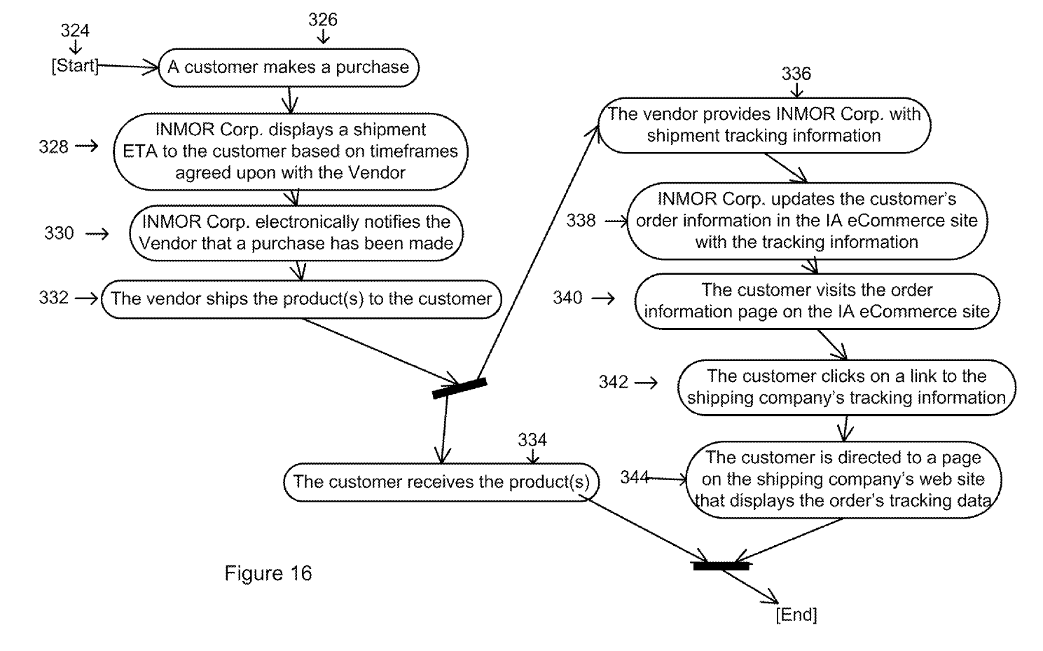

As seen in FIG. 10, the checkout process begins 238 when a customer is ready to purchase items in their shopping cart. The process starts with a customer submitting the items in their shopping cart for check out 240. The customer is asked to review their order 242. The customer is then asked to select from the shipping options available for the vendor(s) of the item(s) in their shopping cart 244. The customer enters the payment information 246. The Merchant companies' flowchart in FIG. 15, described below, provides a detailed view of the payment process. Order and shipping information is transmitted to the vendor for fulfillment 248 and checkout ends 250. The Shipping companies' flowchart in FIG. 16, described below, provides a detailed view of the shipping process.

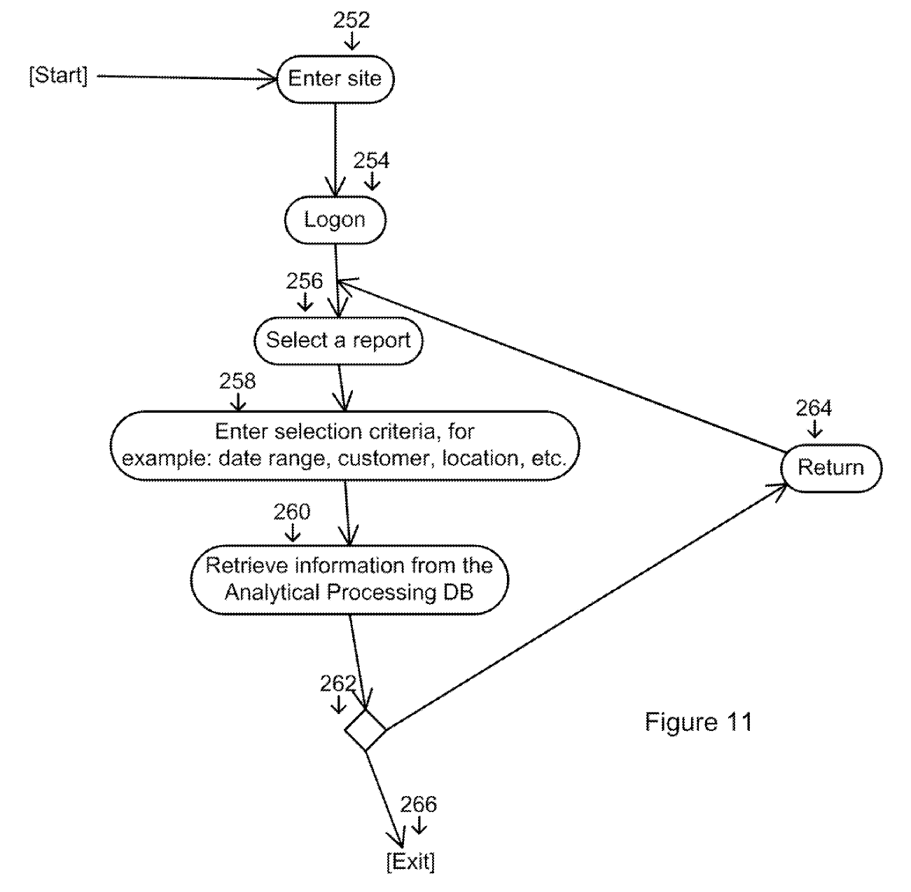

The web layer 34 also includes Reporting, a web site that allows administrators to view reports. Examples of reports are sales dollars and units by vendor, by month, by product category, etc. As seen in FIG. 11, Administrators enter the site 252, log on 254 and select a report 256. The administrator enters the selection criteria (e.g., date range, customer, location, etc.) 258. The administrator then retrieves information from an analytical processing database 260. At that point, the administrator can choose 262 to return 264 to select another report or exit 266.

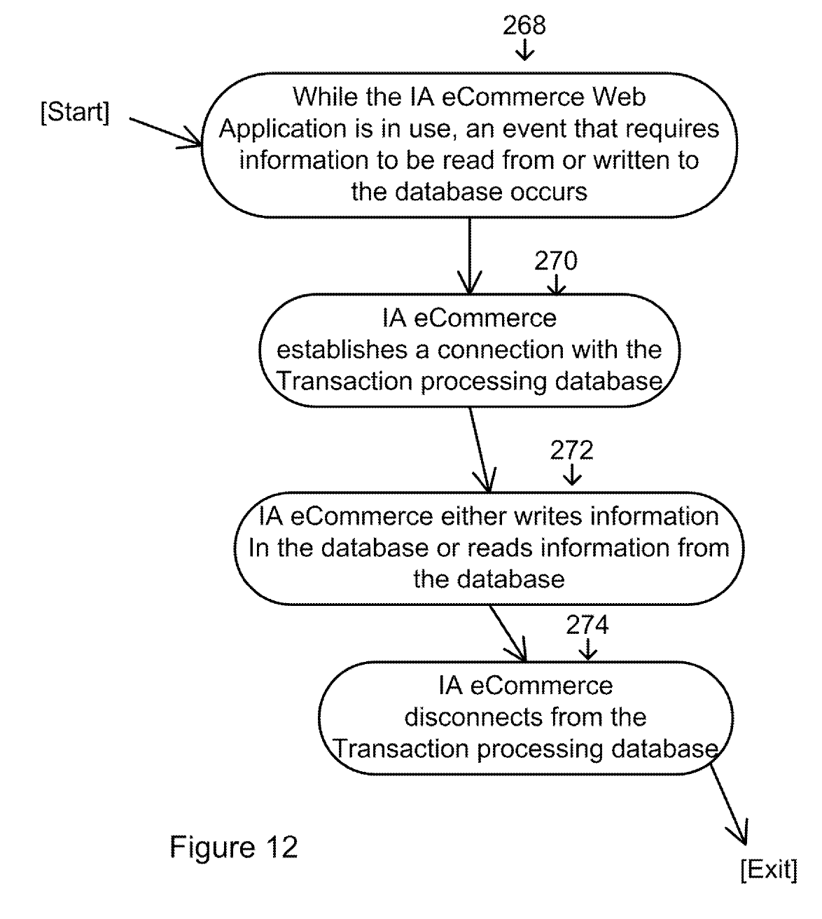

The Data Layer 36 includes a Transaction Processing Database and an Analytical Processing Database. Each database is a collection of data arranged for ease and speed of search and retrieval. The Transaction Processing Database provides functionality to record the purchases and activities of each customer. The database for this environment is provided as part of the web hosting service. As seen in FIG. 12, the transaction purchasing database tracks the purchases and activities of each web visitor. This pattern is followed each time the eCommerce web application interacts with the database. Information is written to the database when a web visitor enters the site, navigates to a new page, places an item in a shopping cart, removes an item from a shopping cart, selects a shipper, selects a payment method, updates account information, and completes a purchase. Information is also written in the database when a vendor provides their product catalog. Information is read from the database that provides product catalog information and web content in numerous languages. Information is also read when the Analytical Processing database extracts information. While the eCommerce web application is in use, an event that requires information to be read from or written to the database occurs 268. The eCommerce web application establishes a connection with the transaction processing database 270. The eCommerce web application either writes information in the database or reads information from the database 272. The eCommerce web application then disconnects from the transaction processing database 274.

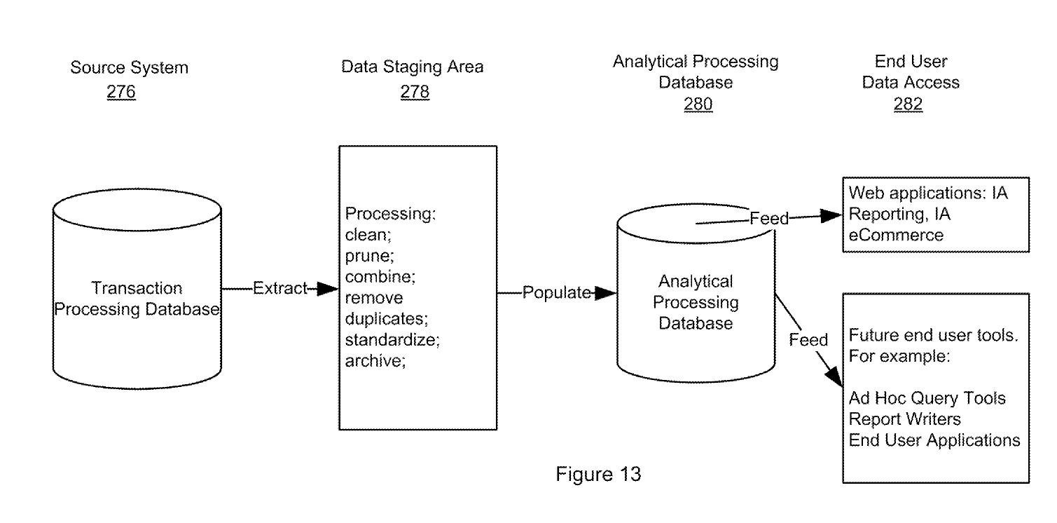

The Analytical Processing Database provides a fast, analytical, multidimensional reporting platform. Information will be extracted from the relational database, transformed, and loaded into the analytical database. The reporting dimensions will include customers, vendors, products, services, locations, times, etc. Analytical reporting is also known as business intelligence (BI) and on-line analytical processing (OLAP). FIG. 13 illustrates that there is a source system (i.e., transaction processing database) 276 from which information is extracted into a data staging area (i.e., processing: clean; prune, combine, remove duplicate; standardize; archive, etc.) 278 which then populates the analytical processing database 280. The analytical processing database then feeds into End User Data Access 282 (e.g., web applications such as Reporting and eCommerce; and future end user tools (e.g., ad hoc query tools, report writers, end user applications, etc.)).

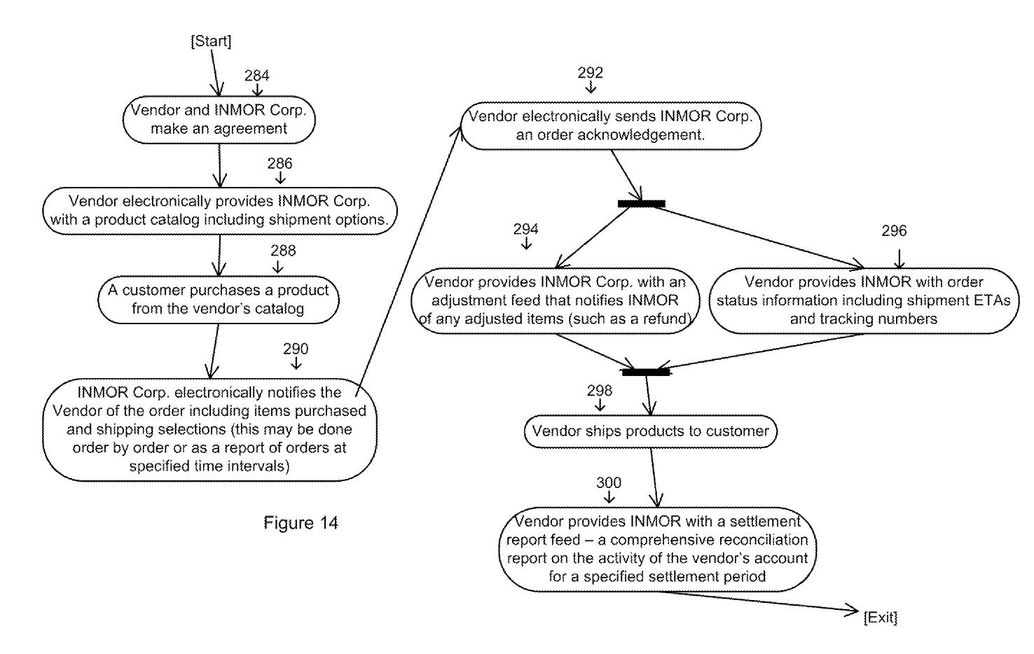

The External Systems layer 38 includes vendors, shipping companies, merchant companies, customer service representatives and technical support staff. The Vendors sell their products and services through the company, as outlined in FIG. 14. The vendor and the company will enter into an agreement in which the company sells the vendor's products through the company website in exchange for a percentage of the sale 284. The vendor will electronically provide the company with a product catalogue including shipment options 286. A customer purchases a product from the vendor catalog 288. The company electronically notifies the vendor of the order including items purchased and shipping selections (this may be done order by order or as a report of orders at specified time intervals) 290. The vendor electronically sends an order acknowledgement 292. The vendor provides the company with an adjustment feed that notifies the company of any adjusted items (such as a refund) 294. The vendor provides the company with order status information including shipment ETAs and tracking numbers 296. The vendor ships products to the customer 298. The vendor provides the company with a settlement report feed (i.e., a comprehensive reconciliation report on the activity of the vendor's account for a specified settlement period) 300.

The Merchant companies provide accounts handling payment processing, as seen in FIG. 15, via Pay Pal, Visa, MasterCard, etc. All orders are done electronically from the customer account to the company's bank. The process starts 302 with a customer submitting a purchase 304. The company eCommerce web-site prompts the customer for their credit card information 306. The customer enters their name as it appears on the credit card, the credit card number, the expiration date of the card, the customer's billing address, etc. 308. The eCommerce site electronically transmits the credit card information to the merchant company with security encryption 310. The merchant company validates the credit card information 312. If the information is accepted, the customer receives a thank you message 314 and the process ends 316. However, if the information is not accepted, then the customer is notified that the payment was declined 318. The customer is then asked if they would like to use a different form of payment (i.e., another credit card, a debit card or the like) 320. If the customer chooses not to use a different form of payment, the order is cancelled 322 and the process ends 316. However, if the customer chooses to use a different form of payment, then the eCommerce site prompts the customer for information about a different credit card 306. The customer enters their name as it appears on the credit card, the credit card number, the expiration date of the card, the customer's billing address, etc. 308. The eCommerce site electronically transmits the credit card information to the merchant company with security encryption 310. The merchant company validates the credit card information 312. If the information is accepted, the customer receives a thank you message 314 and the process ends 316.

The Shipping companies (e.g., FedEx, Airborne Express, USPS, etc) deliver products to customers, as illustrated in FIG. 16. The process starts 324 with a customer making a purchase 326. The company web-site displays a shipment ETA to the customer based on timeframes agreed upon with the vendor 328. The company web-site electronically notifies the vendor that a purchase has been made 330. The vendor ships the product(s) to the customer 332. Thereafter, the customer receives the product(s) 334. Then the vendor provides the company with shipment tracking information 336. The company updates the customer's order information on the eCommerce website with the tracking information 338. The customer visits the order information page on the eCommerce website 340. The customer clicks on a link to the shipping company's tracking information 342. The customer is directed to a page on the shipping company's web site that displays the order's tracking data 344.

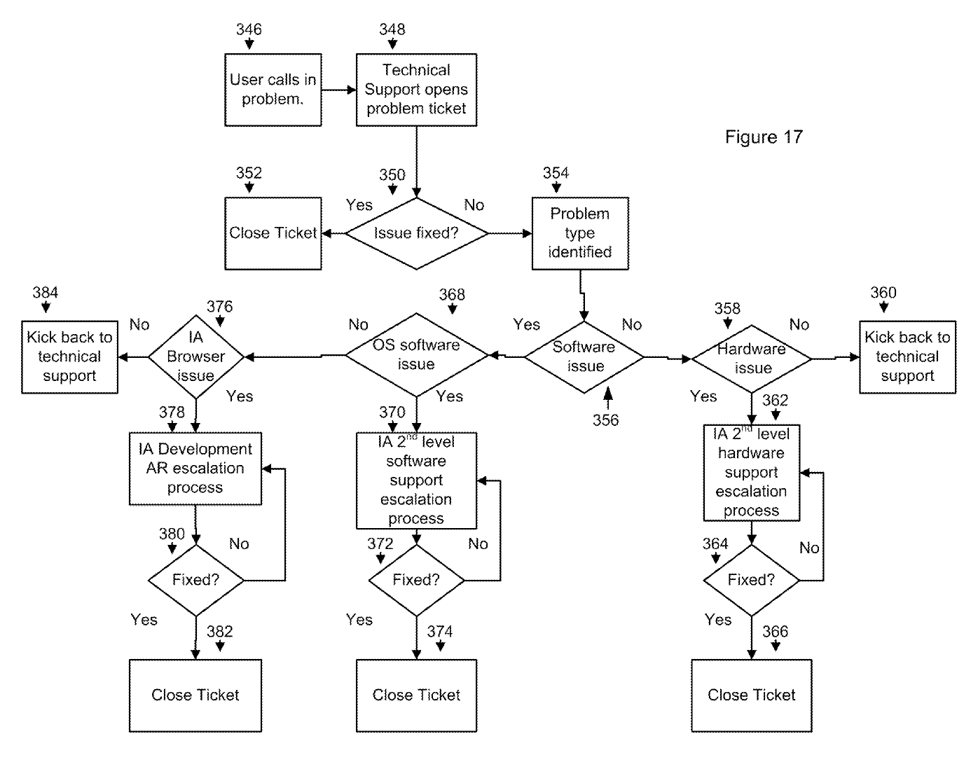

Technical Support will be provided to customers by the company and Customer Service will also be provided by the company to customers 24 hours a day, seven days a week, as illustrated in FIG. 17. Customer service representatives handle non-technical inquires from customers (e.g., billing and/or shipping questions, etc.). Technical support handles technology-related questions from company web browser users. These technology-related questions can be related to connectivity, user error, and installation problems. The technical support staff will also report any systemic problems to administrators. A user can call in a problem 346. Technical support opens a problem ticket 348. Technical support either fixes the issue or not 350. If the issue is fixed, then the ticket is closed 352. If not, then technical support identifies the type of problem 354. The problem may be a software issue 356. If the issue is not software, then it is determined if the problem is a hardware issue 358. If not a hardware issue, technical support then reconsiders the problem 360. If there is a hardware issue, then a second level hardware support escalation process is activated 362. The issue of whether or not the hardware problem is fixed is considered 364. If the hardware problem is not fixed, then the second level hardware support escalation process is activated repeatedly until the problem is fixed 362, 364. If the problem is fixed, then the ticket is closed 366. However, if there is a software issue, then it is determined if there is an operating system (OS) software issue 368. If there is an operating system (OS) software issue, then second level software support escalation process is activated 370. The issue of whether or not the software problem is fixed is considered 372. If the problem is not fixed, then second level software support escalation process is activated repeatedly until the problem is fixed 370, 372. If the problem is fixed, then the ticket is closed 374. However, if it is determined that there is not an OS software issue, it is then determined if there is a company browser issue 376. If not a browser issue, technical support then reconsiders the problem 384. If there is a browser issue, then Development AR escalation process is activated 378. The issue of whether or not the problem is fixed is considered 380. If the problem is not fixed, then Development AR escalation process is activated repeatedly until the problem is fixed 378, 380. If the problem is fixed, then the ticket is closed 382.

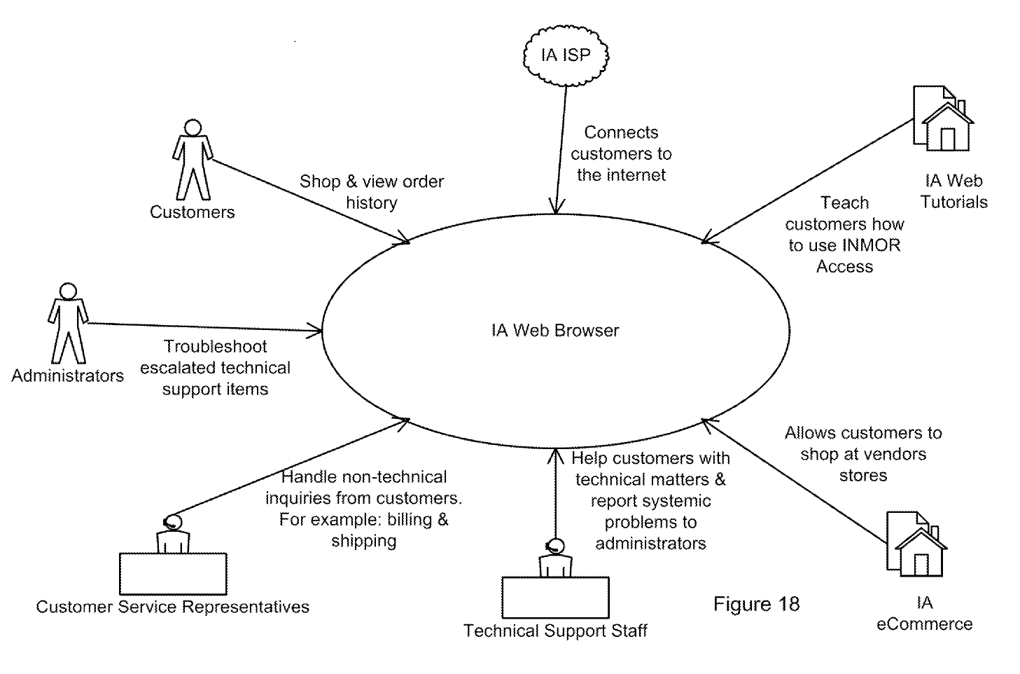

As seen in FIG. 18, the company web browser is a custom web browser developed for the present invention that is installed on the PCs provided to customers and serves as a central hub. In the alternative, existing web-browsers can be modified. Customers will use the company web browser to connect to the eCommerce web site and to browse the internet. As with any web browser, there are risks from viruses—web browsers are often the entry point for viruses onto computers. The company web browser is a Windows application and technical support staff will be available to clients to assist in deployment and maintenance. Providing support for plugins such as Windows Media Player, Macromedia Shockwave, RealPlayer, Quicktime, Java, and Flash will be provided by a dedicated staff of developers.

The web browser has functional requirements (i.e., describes functions and features the users need for the system to work). The web browser automatically logs in the customer to the eCommerce web site when the computer is turned on. This may be done via a custom startup script for Windows. The web browser will also track the history of web sites visited via writing custom web history tracking software. The web browser also has nonfunctional requirements that are critical to the operation of the web browser. These nonfunctional requirements, also called “quality attributes,” specify system characteristics that are required for acceptance of the system by the end user. Examples of nonfunctional requirements are reliability, availability, security, usability, and performance. The nonfunctional requirements include a user interface that is aesthetically pleasing via a custom company skin for Internet Explorer or other existing web browser. Customers using the company web browser will primarily consist of people that have little or no experience with computers; therefore the company web browser should be intuitive and easy to use.

The web browser will have interaction with external systems including eCommerce (the web site that allows customers to login and shop at vendor's stores), the ISP Tutorials (targeted primarily at novice users and deployed via the web and Windows), Technical Support and Customer Service.

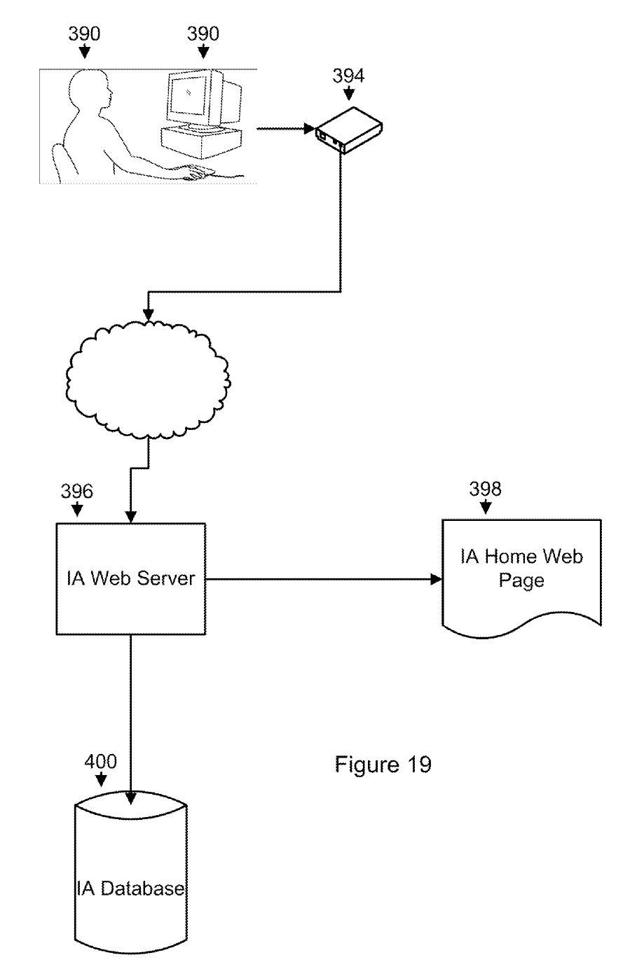

The login process is illustrated in FIG. 19. Once the user 390 boots up the PC 392, a dial-up modem 394 connection to the Internet is automatically made to the company web server 396 and the web browser 398. When the company browser opens, it sends a request to the web server to load the company homepage. Cookies can be used to auto-populate the user's login information if desired. The user 390 will then submit the login information via the company homepage 398. The server 396 will then process the request and query the company database 400 to confirm login. Upon confirmation, the login time and session ID will be stored in the company database tables, and the server 396 will then retrieve from the databases, the personalized user information (e.g., transaction history, user preferences, etc.) and generate a custom user welcome page. The welcome page banners and ads can be tailored to the user's preferences and transaction history. The user 390 will then select from the welcome page their next action: purchase products, browse the web, perform an internet search, etc.

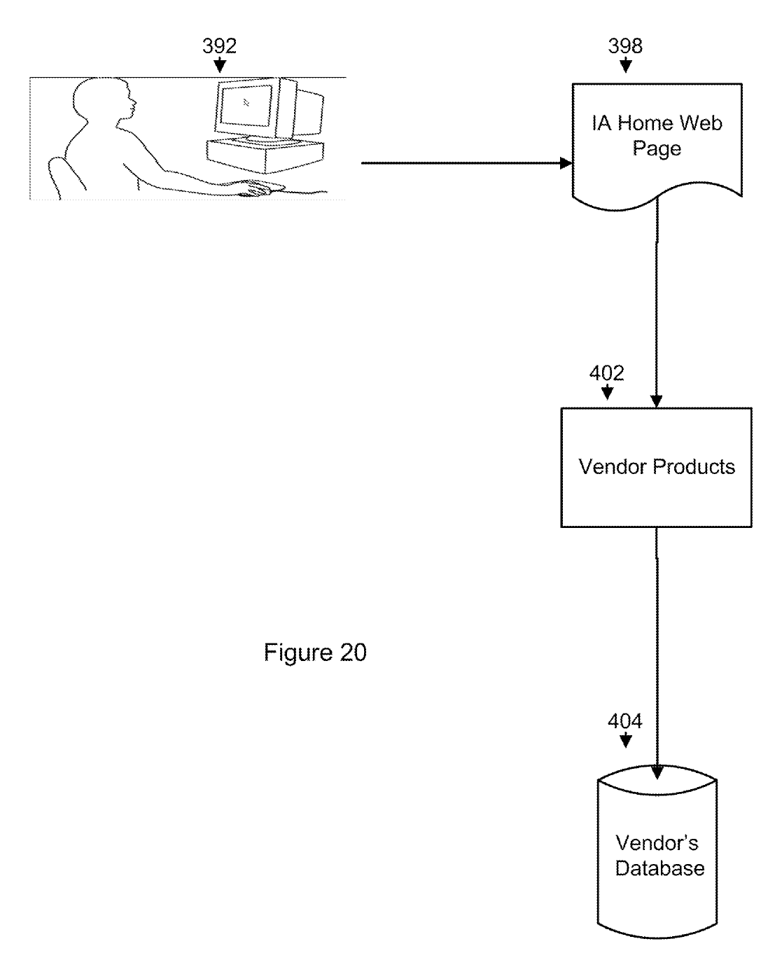

The purchase methodology is illustrated in FIG. 20. If the user 390 requests to purchase products 402, a list of participating vendors will appear. Upon vendor selection by the user, the vendor's database 404 will be queried for currently available types of items. When a type of item is selected by the user, another query is made to the vendor's database for all available items of that type. The user 390 can now select from the page the desired items for purchase to add to their electronic shopping cart. When the user 390 is ready for checkout, their user account information is retrieved from the database tables, containing details on method(s) of payment previously selected by the user 390.

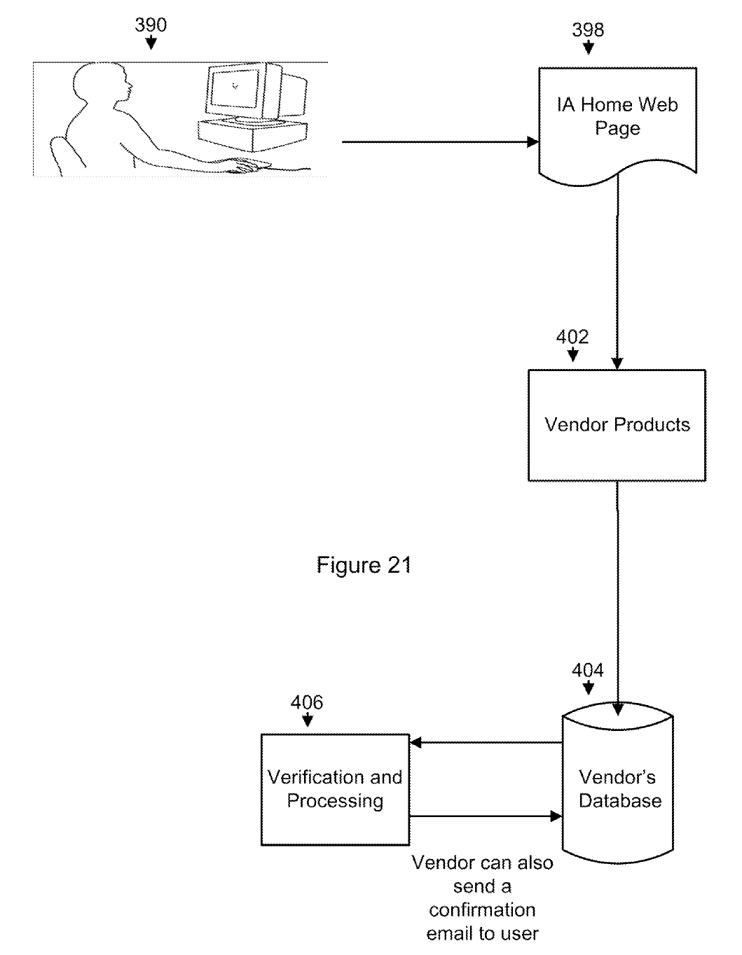

The payment process is illustrated in FIG. 21. Once payment information has been successfully submitted by the user 390, the vendor's database 404 is queried once again to ensure that the item(s) selected are still available for purchase, prior to sending the payment information to the database tables for verification and processing 406. Upon successful processing of the payment, the transaction information, including a list of selected item(s), is passed into the database tables on the web server 396 for transaction logging. A confirmation is instantly sent to the PC screen 392 to confirm that the transaction was successfully completed. The information is also passed to the vendor for order processing and fulfillment. The vendor can also send a confirmation email to the user (and a copy to the company) confirming the completed transaction and shipping status. The vendor communicates to the company when the entire fulfillment process has been completed with the user (all item(s) shipped and received). The communication would best be done either via email, or preferably an auto-upload into database transaction log. This would complete the transaction processing.

In the logoff process, the user is prompted from the company browser to choose to continue shopping with the currently selected vendor, choose a new vendor, browse the web, exit the company browser and use the PC offline, or exit and shut down the PC. If the user chooses to continue shopping, a refresh of the selected vendor's database should be performed to ensure that most current items are displayed as available. If the user chooses to browse the web, sites visited could be captured using the company browser. If the user chooses to exit the company browser and use the PC offline, the logout time and session ID should be captured and stored in the database tables on the web server, and the internet connection should be severed. Other attempts to reconnect to the internet (e.g., launching another web browser to surf the web) are also captured. Upon reconnection, the company browser should automatically be relaunched, in order to encourage users to use the company browser while connected to the internet.

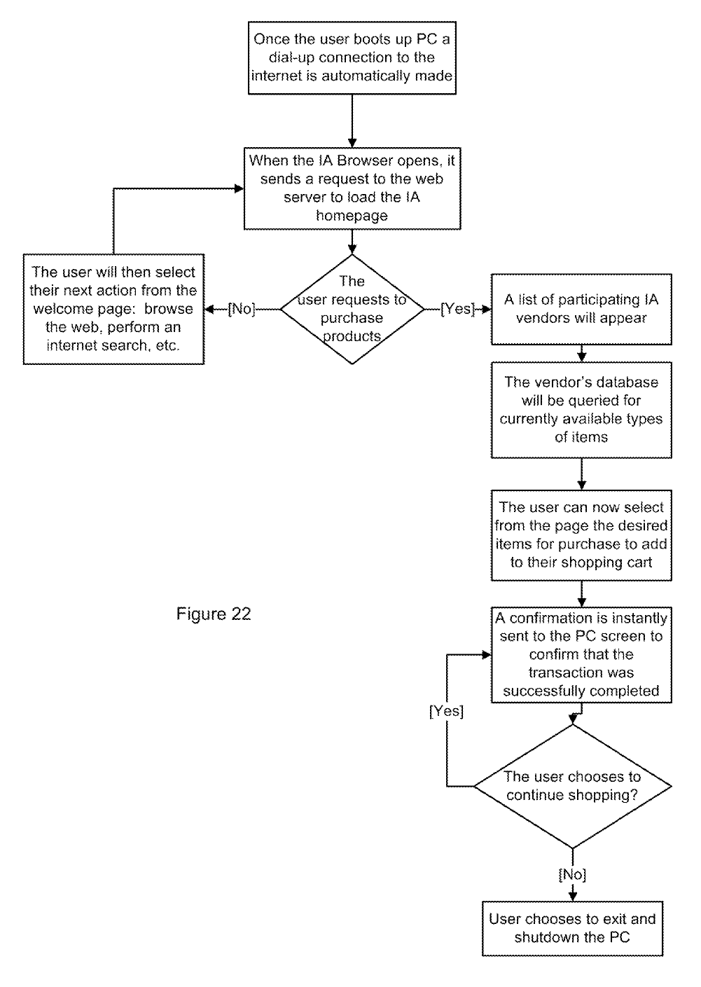

A process that includes booting up the PC, shutting down the PC and other steps in-between is illustrated in FIG. 22. Once the user boots up the PC, a dial-up connection to the Internet is automatically made. When the browser opens, the browser sends a request to the web-server to load the company homepage. The issue then becomes if the user requests to purchase a product or not. If the user does request to purchase a product, the user will then select from the welcome page their next action: purchase products; browse the web; perform an Internet search; etc. If the user chooses to purchase a product, then a list of participating vendors will appear. The vendor's data base will be queried for currently available text of items. The user can then select from the web-site homepage the desired item for purchase to add to their online shopping cart. A communication is instantly sent to the PC screen to confirm that the transaction was successfully completed. The issue is then whether or not the user indicates on the browser whether or not they choose to continue shopping. If they do continue shopping, communication is instantly sent to the PC screen to confirm that the transaction that followed were successfully completed or not. If the user chooses not to continue shopping, the user can choose to exit and shut down the PC.

Technology requirements: Dual network system CPUs are used with company systems linked to the network systems of its web hosting company with Information Technology (IT) being outsourced. All purchases, shipping, payments are performed electronically via email and eCommerce through the hosting company. The company receives sales, filled orders, electronic banking via the web. In the alternative, an in-house system may be used to replace the hosting company.

The above-described embodiment of the present invention is illustrative only and not limiting. It will thus be apparent to those skilled in the art that various changes and modifications may be made without departing from this invention in its broader aspects.

What is claimed is:

1. A process for generating revenue by providing free computers and internet access, comprising the steps of:
enrolling customers in a subscription program wherein the customers agree to purchase a minimum amount of products and/or services from vendors associated with the subscription program;
providing the customers with a free computer and internet access in exchange for the agreement to purchase the minimum amount of products and/or services; and
generating revenue by collecting money from the customers, at least a portion of which goes to the vendors as full payment for the minimum amount of products and/or services purchased.

2. The process of claim 1, further comprising the steps of establishing minimum requirements for enrollment in the subscription program, and requiring applicants to complete a survey to identify those that meet the minimum requirements.

3. The process of claim 2, further comprising the steps of:
identifying those applicants that meet the minimum requirements as prospective customers; and
sending an offer to enroll in the subscription program to the prospective customers.

4. The process of claim 3, further comprising the step of giving prospective customers an option of enrolling in the subscription program on-line or in-person.

5. The process of claim 1, further comprising the steps of:
setting up the free computer and internet access for the customers;
connecting the computer to an e-commerce web-site featuring vendors associated with the subscription program, on which the customers can shop for and purchase various goods and/or services; and
logging the customers onto the e-commerce web-site.

6. The process of claim 5, further comprising the steps of:
permitting the customers to search, browse goods and/or services, add goods and/or services to a shopping cart or wish list, view the shopping cart or wish list, and remove goods and/or services from the shopping cart or wish list on the e-commerce web site;
submitting items contained in the shopping cart for checkout;
receiving payment information from the customer;
transmitting order and shipping information to a vendor for the goods and/or services in the shopping cart; and
fulfilling the customer's order.

7. The process of claim 1, further comprising the step of storing information about the customers in a database, wherein the database already contains information about the vendors and the products and/or services.

8. A process for generating revenue by providing free computers and internet access, comprising the steps of:
enrolling customers in a subscription program wherein the customers agree to purchase a minimum amount of products and/or services from vendors associated with the subscription program;
storing information about the customers in a database, wherein the database already contains information about the vendors and the products and/or services;
providing the customers with a free computer and internet access in exchange for the agreement to purchase the minimum amount of products and/or services;
providing access to a portion of the database through the free computer and internet access, wherein the accessible portion of the database includes information about the vendors, the products and/or services, and the specific customer accessing the database; and
generating revenue by collecting money from the customers, at least a portion of which goes to the vendors as full payment for the minimum amount of products and/or services purchased.

9. The process of claim 8, further comprising the steps of establishing minimum requirements for enrollment in the subscription program; requiring applicants to complete a survey to identify those that meet the minimum requirements; and storing information about the completed surveys in the database.

10. The process of claim 9, further comprising the steps of identifying those applicants that meet the minimum requirements as prospective customers; and sending an offer to enroll in the subscription program to the prospective customers.

11. The process of claim 10, further comprising the step of giving prospective customers an option of enrolling in the subscription program on-line or in-person.

12. The process of claim 8, further comprising the steps of:
setting up the free computer and internet access for the customers;
connecting the computer to an e-commerce web-site with access to the database, on which the customers can shop for and purchase various products and/or services; and
logging the customers onto the e-commerce web-site.

13. The process of claim 12, further comprising the steps of:
permitting the customers to search, browse products and/or services, add products and/or services to a shopping cart or wish list, view the shopping cart or wish list, and remove products and/or services from the shopping cart or wish list on the e-commerce web site;
submitting items contained in the shopping cart for checkout;
receiving payment information from the customer;
transmitting order and shipping information to a vendor for the products and/or services in the shopping cart; and
fulfilling the customer's order.

14. A process for generating revenue by providing free computers and internet access, comprising the steps of:
establishing minimum requirements for enrollment in a subscription program;
requiring applicants to complete a survey to identify those that meet the minimum requirements;
storing information about the completed surveys in a database;
enrolling applicants that meet the minimum requirements in the subscription program wherein the applicants agree to purchase a minimum amount of products and/or services from vendors associated with the subscription program and become customers;
storing information about the customers in the database, wherein the database already contains information about the vendors and the products and/or services;
providing the customers with a free computer and internet access in exchange for the agreement to purchase the minimum amount of products and/or services;
setting up the free computer and internet access for the customers;
providing access to a portion of the database through the free computer and internet access, wherein the accessible portion of the database includes information about the vendors, the products and/or services, and the specific customer accessing the database;
connecting the computer to an e-commerce web-site with access to the database;
logging the customers onto the e-commerce web-site; and
generating revenue by collecting money from the customers, at least a portion of which goes to the vendors as full payment for the minimum amount of products and/or services purchased.

15. The process of claim 14, further comprising the steps of identifying those applicants that meet the minimum requirements as prospective customers; and sending an offer to enroll in the subscription program to the prospective customers.

16. The process of claim 15, further comprising the step of giving prospective customers an option of enrolling in the subscription program on-line or in-person.

17. The process of claim 15, further comprising the steps of:
permitting the customers to search, browse products and/or services, add products and/or services to a shopping cart or wish list, view the shopping cart or wish list, and remove products and/or services from the shopping cart or wish list on the e-commerce web site;
submitting items contained in the shopping cart for checkout;
receiving payment information from the customer;
transmitting order and shipping information to a vendor for the products and/or services in the shopping cart; and
fulfilling the customer's order.
